(19) United States
(12) Patent Application Publication
(10) Pub. No.: US 2025/0121779 A1
(43) Pub. Date: Apr. 17, 2025

(54) BRACKET WITH MULTIPLE LAYERS OF SPACE FOR CLAMPING MOBILE PHONE

(71) Applicant: Binyi CAI, Ganzhou City (CN)

(72) Inventor: Binyi CAI, Ganzhou City (CN)

(21) Appl. No.: 18/510,625

(22) Filed: Nov. 15, 2023

(30) Foreign Application Priority Data
Oct. 17, 2023 (CN) 2023227816234

(51) Int. Cl. B60R 11/02; B60R 11/00; F16B 2/12

(52) U.S. Cl. CPC B60R 11/0241; F16B 2/12; B60R 2011/0071

(57) ABSTRACT

The present disclosure relates to the technical field of mobile phone bracket and provides a bracket with multiple layers of space for clamping mobile phone, which comprises a main body; the main body is provided with a clamping structure; wherein the clamping structure is provided with a first space capable of clamping a mobile phone as well as a second space capable of accommodating the thickness of the back of the mobile phone protruding from the first space. The bracket with multiple layers of space for clamping mobile phone is able to accommodate a mobile phone case with a case back that is too thick as well as a mobile phone with a finger ring accessory.

### TECHNICAL FIELD OF THE INVENTION

The present disclosure relates to the technical field of mobile phone bracket, specifically relates to a bracket (or holder) with multiple layers of space for clamping mobile phone.

### BACKGROUND OF THE INVENTION

With the development of society, nowadays people usually use their mobile phones for route navigation in the process of driving their cars to their destinations, and in order to enable drivers to observe their mobile phones more clearly, mobile phone brackets (mobile phone holders) capable of being fixed to the panels of the car appear on the market, and after installing their mobile phones into the mobile phone brackets, drivers can observe the navigation routes on their mobile phones clearly. Currently, there are many mobile phone brackets on the market that are designed with a single layer of space, however, these mobile phone brackets are usually only suitable for mobile phones with a thin thickness, and are unable to accommodate mobile phone cases that are too thick and mobile phones that have a finger ring accessory.

### SUMMARY OF THE INVENTION

In order to overcome the deficiencies of the prior art, the present disclosure provides a bracket with multiple layers of space for clamping (or gripping, holding) mobile phone to be able to accommodate a mobile phone case with a case back that is too thick as well as a mobile phone with a finger ring accessory.

The present disclosure is realized by the following technical solution:

A bracket with multiple layers of space for clamping mobile phone comprises a main body; the main body is provided with a clamping structure; wherein the clamping structure is provided with a first space capable of clamping a mobile phone as well as a second space capable of accommodating the thickness of the back of the mobile phone protruding from the first space.

Preferably, the sum of the thickness of the first space and the second space is 3 mm˜42 mm.

Preferably, after the clamping structure clamps the mobile phone, the front side of the mobile phone does not protrude from the first space.

Preferably, the clamping structure comprises a first left sidewall and a first right sidewall, the first space is located between the first left sidewall and the first right sidewall; the clamping structure comprises a second left sidewall and a second right sidewall, the second space is located between the second left sidewall and the second right sidewall; the first left sidewall is connected to the second left sidewall, the first right sidewall is connected to the second right sidewall.

Preferably, at least one sidewall of the second space is provided as a first sloping surface inclined outwardly with respect to a thickness direction of the second space.

Preferably, the clamping structure comprises a left step and a right step, the first left sidewall and the second left sidewall are connected to each other by the left step, the first right sidewall and the second right sidewall are connected to each other by the right step; at least one of the left step and the right step is provided to incline outwardly relative to the thickness direction of the second space.

Preferably, the at least one sidewall of the first space is provided as a second sloping surface inclined inwardly with respect to the thickness direction of the first space.

Preferably, the width of the first space and/or the second space is set adjustable; and/or, the first space and/or the second space is width adjustable by unilateral sidewall movement.

Preferably, the clamping structure comprises a fixing member, the fixing member is movably provided on the main body, and the side walls on the same side of the first space and the second space are able to move synchronously with the fixing member.

Preferably, the main body is provided with a support structure capable of supporting the bottom of the mobile phone.

Compared with the prior art, the present disclosure includes the following advantageous effects: the bracket with multiple layers of space for clamping mobile phone of the present disclosure is provided with a first space capable of clamping a mobile phone and a second space capable of accommodating the thickness of the back of the mobile phone protruding out of the first space. The mobile phone case with a back that is too thick and the mobile phone with the finger ring accessory are mounted into the bracket with multiple layers of space for clamping mobile phone of the present disclosure, and then the second space is capable of accommodating the excessively thick portion of the back of the mobile phone case and the finger ring accessory, so that the bracket with multiple layers of space for clamping a mobile phone of the present disclosure is capable of accommodating a mobile phone case with excessively thick back and a mobile phone with a finger ring accessory, and the mobile phone is more stably mounted.

### BRIEF DESCRIPTION OF THE DRAWINGS

FIG. 1 shows a three-dimensional view of a bracket with multiple layers of space for clamping a mobile phone in an embodiment of the present disclosure;

FIG. 2 shows a top view of a bracket with multiple layers of space for clamping a mobile phone in an embodiment of the present disclosure;

FIG. 3 shows a front view of the bracket with multiple layers of space for clamping a mobile phone in an embodiment of the present disclosure;

FIG. 4 shows a schematic diagram of a mobile phone in a tilted state guided to a first space during clamping in an embodiment of the present disclosure;

FIG. 5 shows a schematic view of a mobile phone being mounted to a bracket with multiple layers of space for clamping mobile phone in an embodiment of the present disclosure;

FIG. 6 shows a schematic diagram of the bracket with multiple layers of space for clamping a mobile phone in an embodiment of the present disclosure after increasing the width of the first space;

FIG. 7 shows a schematic diagram of the bracket with multiple layers of space for clamping a mobile phone in an embodiment of the present disclosure after decreasing the width of the first space.

Reference signs: 1, main body; 2, clamping structure; 3, first space; 4, second space; 5, first left sidewall; 6, first right sidewall; 7, second left sidewall; 8, second right sidewall; 9, first sloping surface; 10, left step; 11, right step; 12, second sloping surface; 13, fixing member; 14, thread; 15, guiding member; 16, support structure; 17, left support plate; 18, right support plate.

### DETAILED DESCRIPTION OF THE PREFERRED EMBODIMENT

This part will describe in detail the specific embodiments of the present disclosure, and the preferred embodiments of the present disclosure are shown in the accompanying drawings, which serve to supplement the description of the textual portion of the specification with graphics, so as to enable a person to intuitively and imaginatively comprehend each of the technical features and the overall technical solution of the present disclosure, but which cannot be construed as a limitation on the protection scope of the present disclosure.

In the description of the present disclosure, it is to be understood that the orientation descriptions, such as “up, down, forward, backward, left, right” and the like, indicate an orientation or positional relationship based on the orientation or positional relationship shown in the accompanying drawings, and are only for the purpose of facilitating the description of the present disclosure and simplifying the description, and are not intended to indicate or imply that the device or element referred to must have a specific orientation, be constructed and operated with a specific orientation, and therefore are not to be construed as a limitation on the scope of protection of the present disclosure.

In the description of the present disclosure, “several” means one or more, “a plurality” means more than two, “greater than”, “less than”, “more than” etc. are understood to exclude the present number, and “above”, “below”, “within” etc. are understood to include the present number. If there is a description to “first”, “second” is only used for the purpose of distinguishing the technical features, and is not to be construed as indicating or implying relative importance or implicitly specifying a number of the indicated technical features or implicitly specifying a sequential relationship of the indicated technical features.

In the description of the present disclosure, unless otherwise expressly limited, the words “set”, “installation”, “connection” etc. shall be broadly construed, and the technical person in the technical art can reasonably determine the specific meaning of the above words in the present disclosure in conjunction with the specific content of the technical solution.

Referring to FIGS. 1 to 3, a preferred embodiment of the bracket with multiple layers of space for clamping mobile phone in the present disclosure, the bracket comprises a main body 1; the main body 1 is provided with a clamping structure 2; wherein the clamping structure 2 is provided with a first space 3 capable of clamping a mobile phone and a second space 4 capable of accommodating the thickness of the back of the mobile phone protruding out of the first space 3. The bracket with multiple layers of space for clamping a mobile phone of the present disclosure is provided with a first space 3 capable of clamping a mobile phone and a second space 4 capable of accommodating the thickness of the back of the mobile phone protruding out of the first space 3, after the mobile phone case with a back that is too thick and the mobile phone with the finger ring accessory are mounted into the bracket with multiple layers of space for clamping mobile phone of the present disclosure, the second space 4 then is capable of accommodating the excessively thick portion of the back of the mobile phone case and the finger ring accessory, so that the bracket with multiple layers of space for clamping a mobile phone of the present disclosure is capable of accommodating a excessively thick mobile phone case and a mobile phone with a finger ring accessory, and the mobile phone is more stably mounted.

As a preferred embodiment of the bracket with multiple layers of space for clamping a mobile phone in the present disclosure, it can also have the following additional technical features:

In the present disclosure, the sum of the thicknesses of the first space 3 and the second space 4 is not limited, and can be set according to actual needs. In an optional embodiment, the sum of the thicknesses of the first space 3 and the second space 4 is between 3 mm and 42 mm, and the adoption of the above parameter makes the bracket with multiple layers of space for clamping mobile phone of the present disclosure compatible with most of the excessively thick mobile phone cases and mobile phones with finger ring accessories. In other embodiments, it can be that the sum of the thicknesses of the first space 3 and the second space 4 is a parameter outside the range of 3 mm to 42 mm.

In an optional embodiment, after the clamping structure 2 clamps the mobile phone, the front side of the mobile phone does not protrude from the first space 3. In this way, it is possible to make the clamping structure clamping the mobile phone more stable and reliable, and in addition, it is possible to make the appearance more beautiful. In other embodiments, it can be that after the clamping structure 2 clamps the mobile phone, the front side of the mobile phone protrudes from the first space 3.

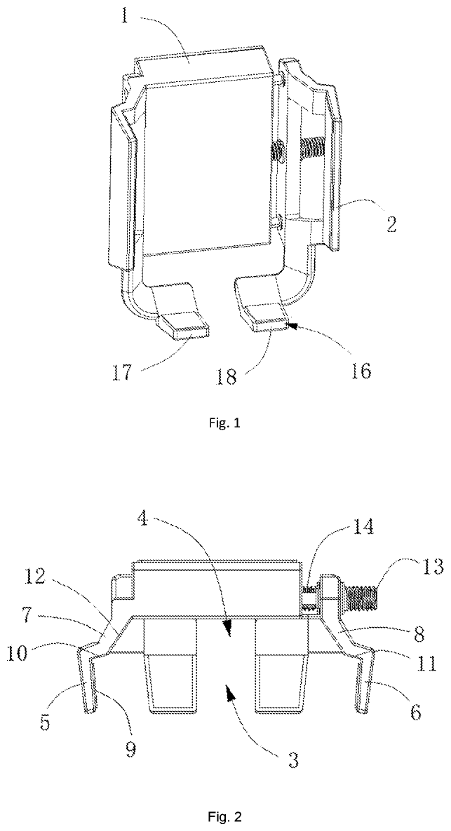

In the present disclosure, the specific structure of the clamping structure 2 is not limited, and can be set according to the actual needs. Referring to FIG. 2, in an optional embodiment, the clamping structure 2 includes a first left sidewall 5 and a first right sidewall 6, and the first space 3 is disposed between the first left sidewall 5 and the first right sidewall 6; the clamping structure 2 includes a second left sidewall 7 and a second right sidewall 8, and the second space 4 is disposed between the second left sidewall 7 and the second right sidewall 8; the first left sidewall 5 is connected with the second left sidewall 7, and the first right sidewall 6 is connected with the second right sidewall 8. With the above structure, the structure is simpler, and it is easy to manufacture the bracket with multiple layers of space for clamping mobile phone of the present disclosure, and can meet the functional requirements. In other embodiments, it is possible that the clamping structure 2 adopts other suitable structures, as long as it has a first space 3 capable of clamping a mobile phone and a second space 4 capable of accommodating the thickness of the back of the mobile phone protruding from the first space 3.

Further, in the present disclosure, it can be that the first left sidewall 5 is directly connected or indirectly connected to the second left sidewall 7, and it can be that the first right sidewall 6 is directly connected or indirectly connected to the second right sidewall 8, which can be set up according to the actual needs.

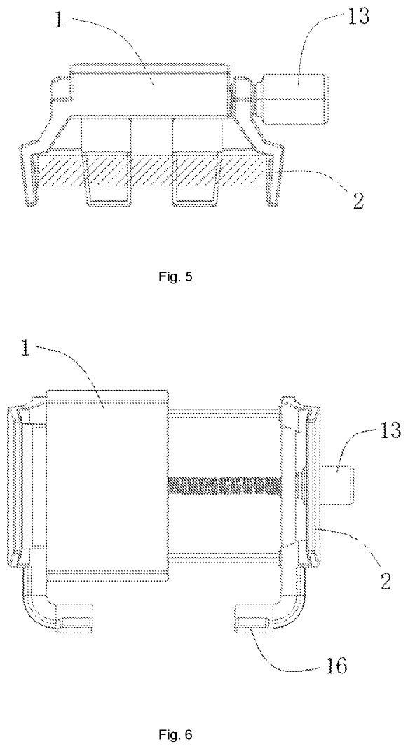

Referring to FIGS. 2, 4 and 5, in an optional embodiment, at least one sidewall of the second space 4 is provided as a first sloping surface 9 inclined outwardly with respect to the thickness direction of the second space 4. Exemplarily, it can be that the one sidewall of the second space 4 is provided as a first sloping surface 9 inclined outwardly with respect to the thickness direction of the second space 4, and it can be that both sidewalls of the second space 4 are provided as first sloping surfaces 9 inclined outwardly with respect to the thickness direction of the second space 4. With the above-described structure, when a user installs a mobile phone into the bracket with a multi-layer space for clamping a mobile phone of the present disclosure, the mobile phone is partially extended into the second space 4 because of tilting without being mounted squarely into the first space 3, and the part of the mobile phone extended into the second space 4 because of tilting is able to slide into the first space 3 along the sidewall of the second space 4 (i.e. the first sloping surfaces 9) under the effect of the clamping force of the clamping structure, and the sidewall of the second space 4, i.e. the first sloping surface 9 plays a guiding role, so as to make the installation of the mobile phone into the bracket with multiple layers of space for clamping the mobile phone of the present disclosure easier, and more convenient for the user to use. In other embodiments, it can be that the at least one sidewall of the second space 4 is provided as a first sloping surface 9 inclined inwardly with respect to the thickness direction of the second space 4. In other embodiments, it can be that the sidewalls of the second space 4 are all provided as vertical surfaces parallel to the thickness direction of the second space 4. In other embodiments, it can also be that the sidewalls of the second space 4 are of other suitable structures and are not limited thereto.

Further, in an optional embodiment, the clamping structure 2 comprises a left step 10 and a right step 11, the first left sidewall 5 and the second left sidewall 7 are connected by the left step 10, and the first right sidewall 6 and the second right sidewall 8 are connected by the right step 11; at least one of the left step 10 and the right step 11 is set to incline outwardly with respect to the thickness direction of the second space 4. Exemplarily, it can be that the left step 10 is set to incline outwardly with respect to the thickness direction of the second space 4, or it can be that the right step 11 is set to incline outwardly with respect to the thickness direction of the second space 4, or it can be that both the left step 10 and the right step 11 are provided to be inclined outwardly with respect to the thickness direction of the second space 4. With the above structure, in the process of the part of the mobile phone that extends into the second space 4 due to tilting sliding into the first space 3 along the sloping surfaces of the sidewall of the second space 4, the left step 10 and/or the right step 11 can play a cushioning role, thereby protecting the safety of the mobile phone sliding into the first space 3 along the sloping surface of the sidewall of the second space 4 even more, and reducing the occurrence of the damage of the mobile phone. In other embodiments, it can be that at least one of the left step 10 and the right step 11 is provided to be inclined inwardly with respect to the thickness direction of the second space 4. In other embodiments, it can be that both the left step 10 and the right step 11 are provided as vertical surfaces parallel to the thickness direction of the second space 4. In other embodiments, it is also possible that both the left step 10 and the right step 11 are provided in other suitable structures and are not limited thereto.

In an optional embodiment, at least one sidewall of the first space 3 is provided as a second sloping surface 12 inclined inwardly with respect to the thickness direction of the first space 3. Exemplarily, it can be that one sidewall of the first space 3 is provided as a second sloping surface 12 inclined inwardly with respect to the thickness direction of the first space 3, and it can be that the two sidewalls of the first space 3 are provided as second sloping surfaces 12 inclined inwardly with respect to the thickness direction of the first space 3. With the above structure, when the mobile phone is mounted to the bracket with multiple layers of space for clamping the mobile phone of the present disclosure, the sidewall(s) of the first space 3 set as the second sloping surface 12 inclined inwardly with respect to the thickness direction of the first space 3 is (are) able to block the mobile phone from detaching from the first space 3 from the frontal direction, so that the mobile phone is mounted to the bracket with multiple layers of space for clamping the mobile phone of the present disclosure in a more stable and more reliable manner. In other embodiments, it can be that at least one sidewall of the first space 3 is provided as a second sloping surface 12 inclined outwardly with respect to the thickness direction of the first space 3. In other embodiments, it can be that the sidewalls of the first space 3 are all provided as vertical surfaces parallel to the thickness direction of the first space 3.

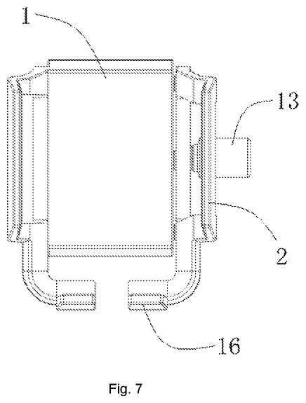

It is to be understood that since different mobile phones have different widths. Referring to FIGS. 6 and 7, in an optional embodiment, the widths of the first space 3 and the second space 4 are adjustable; the first space 3 and the second space 4 are width-adjustable by means of a unilateral sidewall movement. By adopting the above-described structure, it is possible to adjust the widths of the first space 3 according to different mobile phones, so as to make different mobile phones be able to be successfully arranged to the bracket with multiple layers of space for clamping mobile phone in the present disclosure. In addition, since the width of the thickness portion protruding from the first space 3 on the backside of different mobile phones is not the same, the width of the second space 4 is adjustable, which enables the bracket with multiple layers of space for clamping a mobile phone of the present disclosure to be more adaptable to different mobile phones, and furthermore, the width adjustability of the first space 3 and the second space 4 is realized by a unilateral sidewall movement, which makes the width adjustment operation steps of the first space 3 and the second space 4 simpler and more convenient to use. In other embodiments, it can be that the width of the first space 3 or the second space 4 is adjustable. In other embodiments, it can be that the width of the first space 3 or the second space 4 is adjustable by a single sidewall movement. In other embodiments, it can be that the width of the first space 3 and/or the second space 4 is non-adjustable. In other embodiments, it can be that the first space 3 and/or the second space 4 are width adjustable by bilateral sidewall movement.

Referring to FIG. 2, in an optional embodiment, the clamping structure 2 comprises a fixing member 13, the fixing member 13 is movably disposed on the main body 1, and the sidewalls on the same side of the first space 3 and the second space 4 are capable of moving in synchronization with the fixing member 13. By adopting the above-described structure, the width of the first space 3 and the second space 4 can be adjusted by simply operating the fixing member 13 to move, which is more convenient and efficient. In other embodiments, it is possible that the clamping structure 2 adopts other suitable structures instead of the above structure, and is not limited thereto.

Further, in an optional embodiment, the fixing member 13 is provided with a thread 14, and the fixing member 13 is provided on the main body 1 by the thread 14, and by twisting the fixing member 13, movement of the fixing member 13 can be realized, and when the widths of the first space 3 and the second space 4 need to be adjusted, twisting the fixing member 13 is sufficient, which makes the operation more convenient and highly efficient. In other embodiments, it can be that the fixing member 13 is movably provided on the main body 1 using other suitable structures, and is not limited thereto.

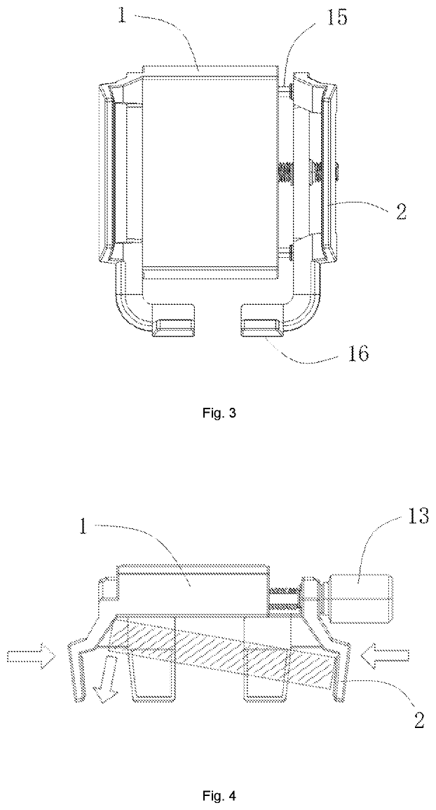

Further, referring to FIG. 3, in an optional embodiment, the clamping structure 2 comprises a guiding member 15, the fixing member 13 is movably disposed on the main body 1, and the sidewalls on the same side of the first space 3 and the second space 4 are able to move in synchronization with the guiding member 15. Adoption of the above-described structure makes the first space 3 and the second space 4 more stable and reliable when adjusting the width thereof. In other embodiments, it can be that the clamping structure 2 does not include the guiding member 15. In other embodiments, it can be that other suitable structures are used instead of the guiding member 15, and it is not limited thereto.

Referring to FIG. 1, in an optional embodiment, the main body 1 is provided with a support structure 16 capable of supporting the bottom of the mobile phone, and by providing the support structure 16, a supporting force can be provided for the bottom of the mobile phone, so that the mobile phone can be prevented from slipping from the bottom of the bracket with multiple layers of space for clamping a mobile phone of the present disclosure after being mounted into the bracket with multiple layers of space for clamping a mobile phone of the present disclosure, and safety and reliability are higher, reducing the occurrence of damage to the mobile phone due to dropping. In other embodiments, it can be that the main body 1 is not provided with a support structure 16 capable of supporting the bottom of the mobile phone.

In an optional embodiment, the width of the support structure 16 and the width of the first space 3 can be adjusted synchronously; the width of the support structure 16 and the width of the second space 4 can be adjusted synchronously. By adopting the above structure, the support structure 16 can better support different mobile phones with higher reliability. In other embodiments, it can be that the width of the support structure 16 and the width of the first space 3 are synchronously adjustable; or, the width of the support structure 16 and the width of the second space 4 are synchronously adjustable. In other embodiments, it can be that the width of the support structure 16 is not synchronously adjusted with the width of the first space 3 and the width of the second space 4.

In the present disclosure, the specific structure of the support structure 16 is not limited, and can be set according to the actual needs. In an optional embodiment, the support structure 16 comprises a left support plate 17 and a right support plate 18; the left support plate 17 is connected to the second left sidewall 7; and the right support plate 18 is connected to the second right sidewall 8. Adopting the above-described structure, the structure is simple and easier to manufacture the bracket with multiple layers of space for clamping a mobile phone of the present disclosure with higher efficiency. In other embodiments, it can be that the left support plate 17 is connected to the first left sidewall 5; it can also be that the left support plate 17 is connected to the first left sidewall 5 and the second left sidewall 7. In other embodiments, it can be that the right support plate 18 is connected to the first right sidewall 6; or it can be that the right support plate 18 is connected to the first right sidewall 6 and the second right sidewall 8. In other embodiments, it can be that the support structure 16 is other suitable structure.

On the premise of no conflict, the person skilled in the art can freely combine as well as superimpose the above additional technical features.

The above embodiments are only preferred embodiments of the present disclosure, and cannot be used to limit the scope of protection of the present disclosure, and any non-substantial changes and substitutions made by a person skilled in the art on the basis of the present disclosure fall within the scope of the protection claimed in the present disclosure.

1. A bracket with multiple layers of space for clamping mobile phone, characterized in that it comprises a main body; the main body is provided with a clamping structure; wherein the clamping structure is provided with a first space capable of clamping a mobile phone as well as a second space capable of accommodating a thickness of a back of the mobile phone protruding from the first space.

2. The bracket with multiple layers of space for clamping mobile phone according to claim 1, characterized in that a sum of the thickness of the first space and the second space is 3 mm˜42 mm.

3. The bracket with multiple layers of space for clamping mobile phone according to claim 1, characterized in that after the clamping structure clamps the mobile phone, a front side of the mobile phone does not protrude from the first space.

4. The bracket with multiple layers of space for clamping mobile phone according to claim 1, characterized in that the clamping structure comprises a first left sidewall and a first right sidewall, the first space is located between the first left sidewall and the first right sidewall; the clamping structure comprises a second left sidewall and a second right sidewall, the second space is located between the second left sidewall and the second right sidewall; the first left sidewall is connected to the second left sidewall, the first right sidewall is connected to the second right sidewall.

5. The bracket with multiple layers of space for clamping mobile phone according to claim 4, characterized in that at least one sidewall of the second space is provided as a first sloping surface inclined outwardly with respect to a thickness direction of the second space.

6. The bracket with multiple layers of space for clamping mobile phone according to claim 5, characterized in that the clamping structure comprises a left step and a right step, the first left sidewall and the second left sidewall are connected to each other by the left step, the first right sidewall and the second right sidewall are connected to each other by the right step; at least one of the left step and the right step is provided to incline outwardly relative to the thickness direction of the second space.

7. The bracket with multiple layers of space for clamping mobile phone according to claim 4, characterized in that at least one sidewall of the first space is provided as a second sloping surface inclined inwardly with respect to a thickness direction of the first space.

8. The bracket with multiple layers of space for clamping mobile phone according to claim 4, characterized in that a distance between the first left sidewall and the first right sidewall is set to be adjustable.

9. The bracket with multiple layers of space for clamping mobile phone according to claim 4, characterized in that a distance between the second left sidewall and the second right sidewall is set to be adjustable.

10. The bracket with multiple layers of space for clamping mobile phone according to claim 8, characterized in that the distance between the first left sidewall and the first right sidewall is adjusted by moving the first left sidewall or the first right sidewall.

11. The bracket with multiple layers of space for clamping mobile phone according to claim 9, characterized in that the distance between the second left sidewall and the second right sidewall is adjusted by moving the second left sidewall or the second right sidewall.

12. The bracket with multiple layers of space for clamping mobile phone according to claim 4, characterized in that the clamping structure comprises a fixing member, the fixing member is movably provided on the main body, and sidewalls on a same side of the first space and the second space are able to move synchronously with the fixing member.

13. The bracket with multiple layers of space for clamping mobile phone according to claim 1, characterized in that the main body is provided with a support structure capable of supporting a bottom of the mobile phone.
